(19) United States
(12) Patent Application Publication
(10) Pub. No.: US 2025/0080041 A1
(43) Pub. Date: Mar. 6, 2025

(54) SMART SOLAR CELL STREETLIGHT

(71) Applicant: DAESEONG WIRELESS CO., LTD., Cheongju-si (KR)

(72) Inventors: Beomki PARK, Cheongju-si (KR); Nari KIM, Cheongju-si (KR)

(73) Assignee: DAESEONG WIRELESS CO., LTD., Cheongju-si (KR)

(21) Appl. No.: 18/889,392

(22) Filed: Sep. 19, 2024

Related U.S. Application Data
(63) Continuation of application No. PCT/KR2023/017195, filed on Nov. 1, 2023.

(30) Foreign Application Priority Data
Sep. 5, 2023 (KR) 10-2023-0117727

(51) Int. Cl. H02S 20/32; F21S 9/03; F21W 131/103; F21Y 115/10; H02S 40/38

(52) U.S. Cl. CPC H02S 20/32; F21S 9/035; H02S 40/38; F21W 2131/103; F21Y 2115/10

(57) ABSTRACT

Disclosed is a smart solar cell streetlight including a solar cell unit that absorbs light and generates electricity, a battery unit that stores the electricity generated by the solar cell unit, an angle changer that is operated by the electricity supplied from at least one of the solar cell unit or the battery unit and changes an angle of the solar cell unit, and a lamp unit that is operated by the electricity supplied from at least one of the solar cell unit or the battery unit and includes a plurality of LEDs.

### BACKGROUND OF THE INVENTION

The present invention relates to a smart solar cell streetlight.

In general, solar photovoltaics is a technology for directly converting solar light into electricity using solar cells, as a pollution-free energy source capable of obtaining energy without emitting greenhouse gases or causing environmental damage.

In this regard, Korean Patent No. 10-1081555 discloses a streetlight in which a solar cell panel is fixed, which has a problem in that electricity productivity is low. In order to solve the problem, Korean Patent No. 10-2023073 discloses a streetlight in which a solar cell panel is rotated, but has a problem in that very complex parts are provided to rotate the solar cell panel and a lot of energy is necessary to operate the solar cell panel, which results in decrease of the efficiency of the streetlight. Further, since the device is huge, its installation is difficult and an installation period becomes long. In addition, since the solar cell panel is disposed at the bottom of the streetlight, there is a problem of blocking light emitted from the streetlight.

### SUMMARY OF THE INVENTION

The present invention has been made in view of the above problems, and it is an object of the present invention to provide a smart solar cell streetlight capable of easily setting a solar cell panel along a moving direction of the sun regardless of the direction of the streetlight, and easily detaching a solar cell unit from a lamp unit. Further, it is another object of the present invention to provide a smart solar cell streetlight having a neat and unified appearance, and enabling quick and easy installation thereof by matching front-to-back directions of the solar cell panel and the lamp unit.

In accordance with the present invention, the above and other objects can be accomplished by the provision of a smart solar cell streetlight including a solar cell unit that absorbs light and generates electricity, a battery unit that stores the electricity generated by the solar cell unit, an angle changer that is operated by the electricity supplied from at least one of the solar cell unit or the battery unit and changes an angle of the solar cell unit, and a lamp unit that is operated by the electricity supplied from at least one of the solar cell unit or the battery unit and includes a plurality of LEDs.

The smart solar cell streetlight may further include a direction setting unit that sets a direction of the angle changer between the angle changer and the lamp unit.

Further, the smart solar cell streetlight may further include a controller that controls at least one of the battery unit, the angle changer, or the lamp unit.

In addition, the smart solar cell streetlight may further include a direction detector that detects a direction of at least one of the direction setting unit or the lamp unit, in which the angle changer may be set toward the east or the west on the basis of the direction detected by the direction detector.

Here, the lamp unit may include a light part provided with the plurality of LEDs and a housing that protects the light part, in which the direction setting unit may include a fixing base provided on an upper surface of the housing, a rotation base having at least six guide grooves arranged at equal intervals around the circumference thereof and fitted into the fixing base, and a direction fixing part that fixes a direction of the rotation base around the fixing base.

In addition, the direction fixing part may include a fixing pin that penetrates a peripheral part of the fixing base and is inserted into or detached from the guide groove at one end thereof, a pin support part that is spaced apart from the fixing base, is provided on the upper surface of the housing, and supports the fixing pin, and an elastic member that maintains the fixing pin inserted into the groove.

The direction setting unit may further include a fixing part that prevents the rotation base from being separated from the fixing base.

According to the present invention, since it is possible to recognize a moving path of the sun on the basis of the detected direction, and to rotate the solar cell unit along the sun's moving path.

In addition, it is possible to set the solar cell unit to be rotated along the moving path of the sun without changing the direction of the solar cell unit in a planar view.

Further, the controller is capable of adjusting the rotation speed of the solar cell unit according to the seasons, thereby maximizing the efficiency of the solar cell panel according to seasonal changes all the time.

Further, by embedding a rechargeable battery, it is possible to operate the streetlight even in a case where the external power supply is cut off.

Further, since it is possible to match front-to-rear directions of the solar cell unit and the lamp unit, it is possible to form neat and unified appearance.

Additionally, the angle changer can be easily attached and detached from the lamp unit.

Furthermore, by embedding the controller in the angle changer, it is possible to easily replace the controller in a case where the controller breaks down.

### BRIEF DESCRIPTION OF THE DRAWINGS

FIG. 1 is a side view schematically showing a smart solar cell streetlight according to an embodiment of the present invention.

FIG. 2 is a perspective view schematically showing

an angle changer in the smart solar cell streetlight according to the embodiment of the present invention.

FIG. 3 is a perspective view schematically showing a part of the angle changer in the smart solar cell streetlight according to the embodiment of the present invention.

FIG. 4 is a plan view schematically showing a state in which the smart solar cell streetlight according to the embodiment of the present invention is disposed to the west.

FIG. 5 is a plan view schematically showing a state in which the smart solar cell streetlight according to the embodiment of the present invention is arranged toward the southwest.

FIG. 6 is an enlarged side sectional view of portion “A” in FIG. 1, schematically showing an operating state of a fixing pin in the smart solar cell streetlight according to the embodiment of the present invention.

FIGS. 7 and 8 are side views schematically showing an operating state of the smart solar cell streetlight according to the embodiment of the present invention.

FIG. 9 is a side view schematically showing an installation state of the smart solar cell streetlight according to the embodiment of the present invention.

### DETAILED DESCRIPTION OF THE INVENTION

Preferred embodiments of the present invention will be described in more detail with reference to the accompanying drawings, but well-known technical parts will be omitted or compressed for brevity of description.

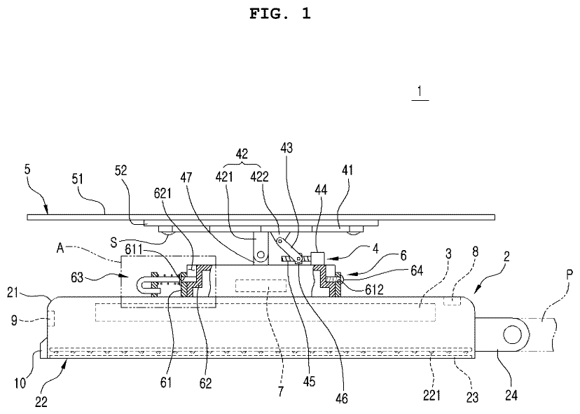

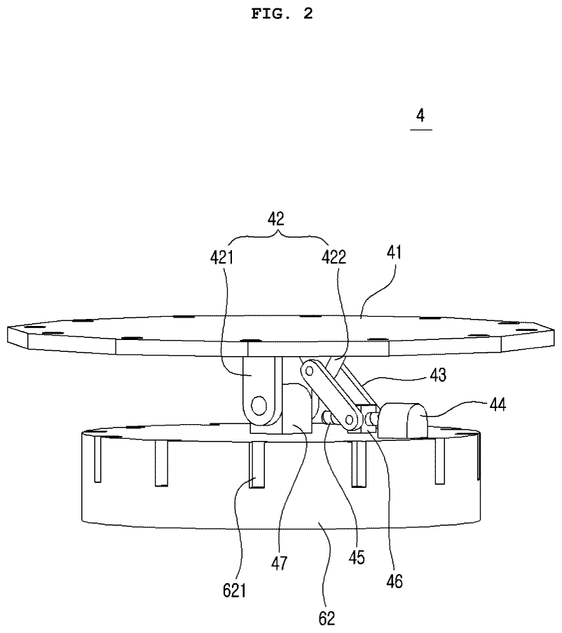

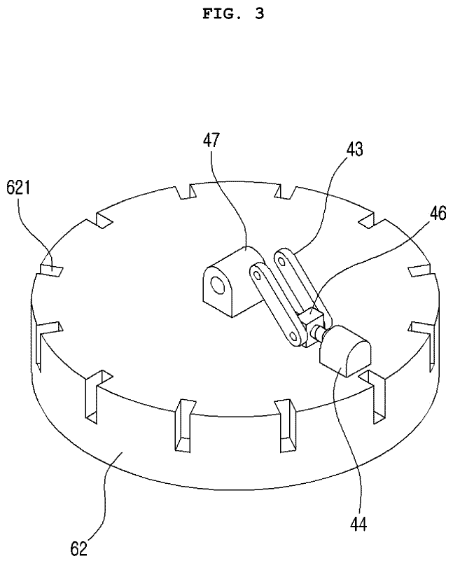

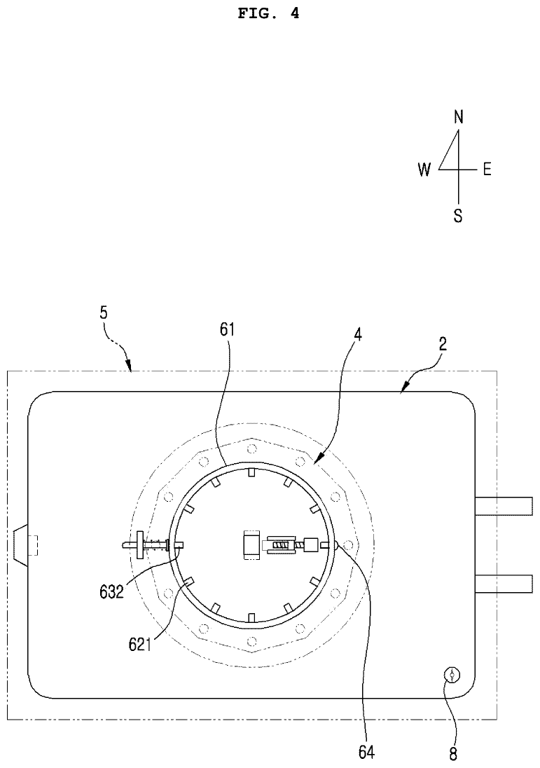

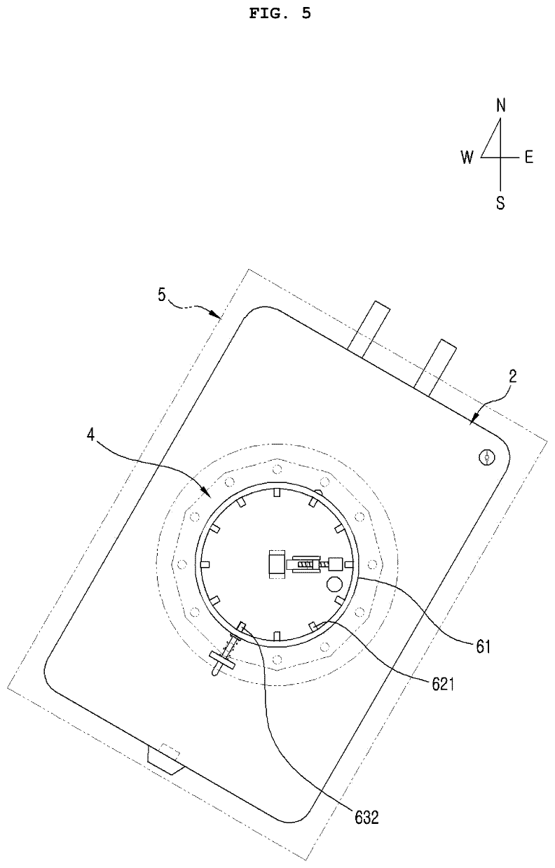

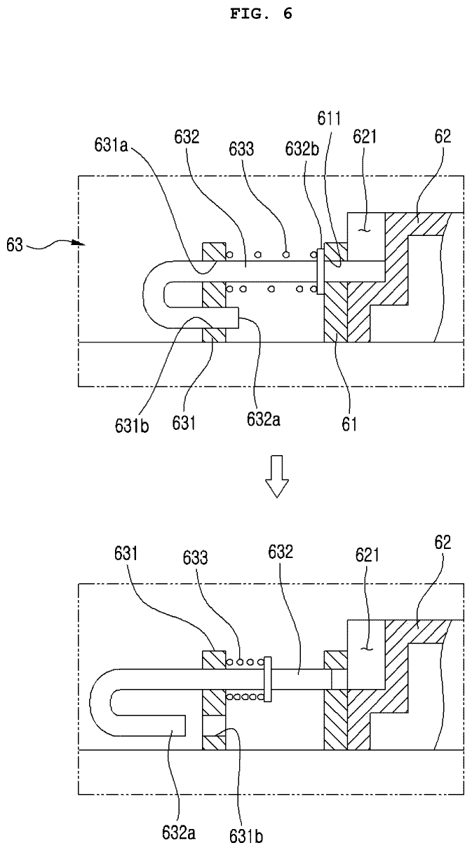

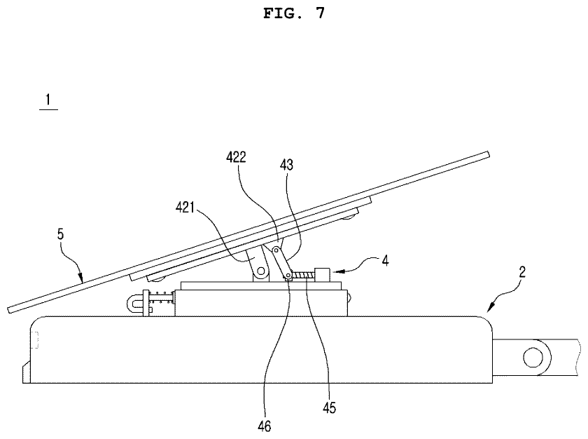

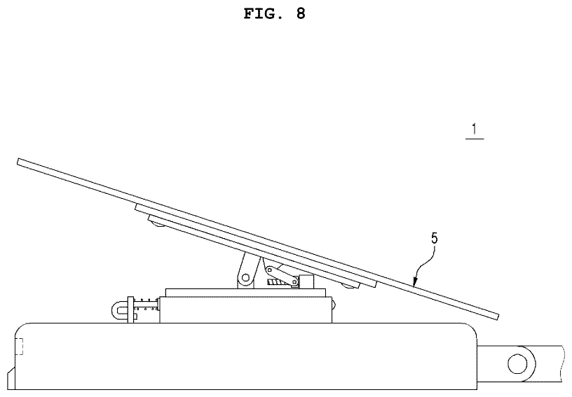

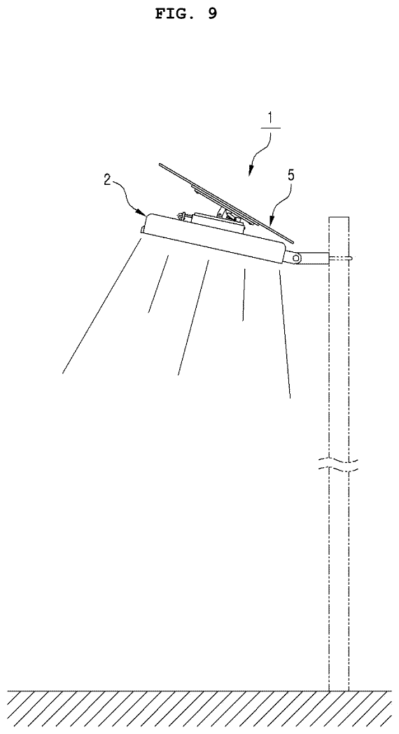

As shown in FIGS. 1 to 9, a smart solar cell streetlight 1 according to an embodiment of the present invention may include a lamp unit 2, a battery unit 3, an angle changer 4, and a solar cell unit 5, a direction setting unit 6, a controller 7, and a direction detector 8.

The lamp unit 2 emits light by power supplied from a solar cell panel 51 or the battery unit 3 (which will be described later), and includes a housing 21, a light part 22, a protection panel 23, and a streetlight fixing part 24.

The housing 21 is configured to protect the light part 22 and the battery unit 3. The housing 21 may be formed in the shape of a disk or a rectangular parallelepiped having an opening at the bottom thereof, and may be fixed to a wall of a building or a telephone pole through the streetlight fixing unit 24.

The light part 22 emits light by power supplied from the solar cell panel 51 or the battery unit 3 and is controlled by the controller 7 to be described later. The light part 22 has a configuration in which a board on which a plurality of LEDs 221 is mounted is disposed inside the housing 21 with the LEDs 221 being directed downward.

The protection panel 23 may collect or disperse light by changing the direction of light emitted from the light part 22. The protection panel 23 is provided at the bottom of the housing 21 to close the bottom opening of the housing 21. Accordingly, it is possible to concentrate light in a specific area or disperse the light over a wide area, and to prevent foreign substances from entering the interior of the housing 21.

The streetlight fixing unit 24 is disposed at a rear end part of the housing 21, and is combined with a streetlight fixing part 64 (P) mounted on the wall of the building or the telephone pole. Further, the streetlight fixing unit 24 may be rotatably combined with the streetlight fixing part 64. Accordingly, it is possible to change an emission angle of the smart solar cell streetlight 1.

The battery unit 3 stores electricity generated from the solar cell panel 51. The battery unit 3 is disposed above the light part 22 inside the housing 21, and supplies power to the LEDs 221, a motor 44 of the angle changer 4, and the controller 7.

The angle changer 4 changes an angle of the solar cell unit 5, which will be described later. The angle changer 4 is mounted on an upper portion of the housing 21, and includes an upper coupling part 41, a rotation bracket 42, a link part 43, the motor 44, a screw 45, a moving block 46, and a bracket coupling part 47.

The upper coupling part 41 is coupled to the solar cell unit 5, and is formed in an approximately circular or polygonal panel shape, in which a plurality of holes is formed at a peripheral portion thereof. The upper coupling part 41 is screw-coupled with a panel fixing part 52 of the solar cell unit 5.

Here, the diameter of the upper coupling part 41 may be formed to be larger than the diameter of a rotation base 62, which will be described later. Accordingly, the solar cell unit 5 and the upper coupling part 41 may be easily coupled by screwing outside the rotation base 62.

The rotation bracket 42 is configured to change the angle of the solar cell unit 5, and includes a first bracket 421 and a second bracket 422.

The first bracket 421 is disposed on a central bottom of the upper coupling part 41 and is rotatably coupled to the bracket coupling part 47, which will be described later. Accordingly, the upper coupling part 41 rotates around a rotational center of the first bracket 421.

The second bracket 422 is spaced apart from the first bracket 421, is disposed on the bottom of the upper coupling part 41, and is rotatably coupled to the link part 43. Detailed description thereof will be made later.

The link part 43 is provided as a pair, one end of which is disposed on each side of the second bracket 422 to be rotatably coupled to the second bracket 422, and the other end of which is disposed on each side of the moving block 46 (which will be described later) to be rotatably coupled thereto. Detailed description thereof will be made later.

The motor 44 is configured to rotate the screw 45, and is disposed on an upper surface of the rotation base 62 at an edge portion thereof. The motor 44 is operated by electricity supplied from at least one of the solar cell panel 51 or the battery unit 3, and is controlled by the controller 7. Detailed description thereof will be made later.

The screw 45 is configured to operate the moving block 46, one end of which is connected to a rotation shaft of the motor 44, and the other end of which is inserted into the moving block 46 to be screw-coupled thereto. Accordingly, in a case where the motor 44 is operated, the screw 45 rotates, and the moving block 46 moves along the screw 45 according to the rotation of the screw 45. Detailed description thereof will be made later.

The moving block 46 is configured to operate the link part 43, and is rotatably coupled to the link part 43. The moving block 46 is inserted into the screw 45 to be screw-coupled thereto. Accordingly, in a case where the moving block 46 moves, the link part 43 is operated, and accordingly, the second bracket 422 moves, and the upper coupling part 41 rotates. That is, in a case where the moving block 46 moves in one direction, the link part 43 pushes and lifts the second bracket 422, and thus, lifts one portion of the upper coupling part 41 to lift one portion of the solar cell part 5, which causes the solar cell panel 51 to be inclined. Contrarily, in a case where the moving block 46 moves in the other direction, the link part 43 pulls the second bracket 422 to thus cause the one portion of the upper coupling part 41 to descend, which causes the solar cell panel 51 to be inclined in the opposite direction. That is, by reciprocally moving the moving block 46, the upper surface of the solar cell panel 51 may be provided to be inclined from the sunrise direction to the sunset direction. Accordingly, it is possible to increase electricity productivity of the solar cell panel 51.

The bracket coupling part 47 is configured to restrain the first bracket 421, is disposed on a central upper surface of the rotation base 62, and rotatably supports the first bracket 421.

The solar cell unit 5 is configured to collect sunlight and converts the light into electricity, and includes the solar cell panel 51 and the panel fixing part 52.

The solar cell panel 51 includes a plurality of solar cells, which collects sunlight and converts the light into electricity. The solar cell panel 51 is disposed on the upper surface of the panel fixing part 52 to be coupled to the panel fixing part 52, and supplies power to at least one of the battery unit 3, the motor 44, or the controller 7. Accordingly, it is possible to store electricity in the battery unit 3 during times when the sun is up, and to change the angle of the solar cell panel 51 by operating the motor 44. Further, in a case where the sun sets or in a dark environment, it is possible to brightly light a dark area by operating the LEDS 221 using the electricity stored in the battery unit 3.

The panel fixing part 52 is coupled to the upper coupling part 41, and has a plurality of screw holes, that is, at least 2 to 6 screw holes formed at positions corresponding to holes of the upper coupling part 41, and screw holes are formed. The panel fixing part 52 is coupled to the upper coupling part 41 through screws. Detailed description thereof will be made later.

The direction setting unit 6 is configured to set the rotation direction of the angle changer 4, and includes a fixing base 61, a rotation base 62, a direction fixing part 63, and a fixing part 64.

The fixing base 61 is configured to guide the rotation base 62, and is disposed on an upper surface of the housing 21. The fixing base 61 is formed in an approximately disk shape having an opening at an upper portion thereof, and has a first hole 611 and a second hole 612 are formed on the circumference thereof. Here, the second hole 612 may be threaded so that the fixing part 64 is screw-coupled thereto.

Additionally, the fixing base 61 may be formed to be lower in height than the rotation base 62. Detailed description thereof will be made later.

The rotation base 62 is configured to rotate and set the direction of the angle changer 4, and is formed in the shape of a disk having an opening at the bottom thereof, in which an outer diameter thereof corresponds to an inner diameter of the fixing base 61 and a plurality of guide grooves 621 are arranged at equal intervals around the circumference thereof.

Further, the rotation base 62 is inserted into the fixing base 61 to be rotatable with respect to the fixing base 61. The guide grooves 621 are opened upward and radially, and correspond to a fixing pin 632 (to be described later) and the fixing part 64. Detailed description thereof will be made later.

Further, the rotation base 62 may be formed to be higher in height than the fixing base 61. Accordingly, an upper portion of the rotation base 62 partially protrudes from the fixing base 61, and the guide grooves 621 of the rotation base 62 protrude by a predetermined height from the side of the fixing base 61, thereby making it possible to easily matching the position of each guide groove 621 and the position of the fixing pin 632, which will be described later. Accordingly, the rotation base 62 may be easily detached from the fixing base 61.

The direction fixing part 63 is configured to detach the rotation base 62 from the fixing base 61, and includes a pin support part 631, the fixing pin 632, and an elastic body 633.

The pin support part 631 is configured to guide and support the fixing pin 632, and is formed in an approximately rectangular panel shape, and is formed with a first through hole 631a corresponding to the first hole 611.

The pin support part 631 is provided on the upper surface of the housing 21, is disposed on the outside of the fixing base 61 to be spaced apart from the first hole 611.

Detailed description thereof will be made later.

The fixing pin 632 is configured to detachably fix the rotation base 62 to the fixing base 61, is inserted into the first hole 611 at one end thereof, and is inserted into the first through hole 631a at the other end thereof. A “U”-shaped stopper 632a is formed on the other end thereof. Here, an end part of the stopper 632a is inserted into a second through hole 631b. In addition, the fixing pin 632 is provided with a disk-shaped support piece 632b that supports the elastic body 633, which will be described later, at one end part thereof.

Detailed description thereof will be made later.

The elastic body 633 is configured to elastically restore the fixing pin 632, and may include a coil spring, or the like. The elastic body 633 is disposed radially outside the fixing pin 632 between the pin support part 631 and the support piece 632b. Accordingly, in a case where the stopper 632a is pulled to the left in FIG. 1, the end part of the stopper 632a is separated from the second through hole 631b, and in a case where the stopper 632a is released after the stopper 632a is rotated in the separated state, the end part of the stopper 632a is caught on the pin support part 631, and the one end part of the fixing pin 632 is maintained in a state of being inserted into the first hole 611. Then, the rotation base 62 is inserted into the fixing base 61 and the stopper 632a is rotated, and accordingly, the one end part of the fixing pin 632 protrudes into the inside of the fixing base 61 by the elastic body 633 and is inserted into the guide groove 621 of the rotation base 62. Thus, the rotation base 62 may remain restrained to the fixing base 61. In this way, the rotation base 62 may be easily detached from the fixing base 61.

The fixing part 64 is configured to fix the rotation base 62 to the fixing base 61, may include a screw, or the like. The fixing part 64 is screwed to the second hole 612, and the fixing part 64 is coupled to the second hole 612. In a case where the fixing part 64 is fully screwed to the second hole 612, an end part of the fixing part 64 protrudes into the inside of the fixing base 61. Accordingly, in a case where the rotation base 62 is inserted into the fixing base 61 and the rotation base 62 is restrained by the fixing pin 632, the second hole 612 and the guide groove 621 of the rotation base 62 automatically match each other. Then, in a case where the fixing part 64 is inserted into the second hole 612 and screwed thereto, the end part of the fixing part 64 is inserted into the matched guide groove 621, so that the rotation base 62 is firmly fixed to the fixing base 61.

The above-described direction fixing part 63 or fixing part 64 may be disposed at a plurality of positions on the upper surface of the housing 21. Accordingly, the rotation base 62 may be more firmly fixed to the fixing base 61.

The controller 7 is configured to control at least one of the charging of the battery unit 3, the operation of the motor 44, or the operation of the LEDs 221. The controller 7 is disposed inside the rotation base 62, and is operated by power supplied from at least one of the solar cell panel 51 or the battery unit 3.

Further, the controller 7 may include data on sunrise and sunset times for each season.

Accordingly, in a case where the sunrise and sunset times vary depending on seasons, the controller 7 may control the rotation speed of the motor 44 on the basis of the sunrise/sunset time data, thereby controlling the rotation speed of the solar cell panel 51 to maximize the electricity productivity of the solar cell panel 51. In addition, the controller 7 may check the remaining amount of electricity in the battery unit 3, and may return the solar cell panel 51 to its original position, that is, in the sunrise direction after sunset.

The direction detector 8 is configured to detect the direction, and is disposed on the upper surface of the housing 21. Accordingly, even in a case where the direction of the smart solar cell streetlight 1 is changed, a worker is capable of recognizing the direction through the direction detector 8, and further, may rotate the direction setting unit 6 to set the angle changer 4 in the east-west direction. In other words, it is possible to rotate and set the direction setting section 6 so that the moving block 46 moves in the east-west direction, and to prevent the solar cell unit 5 from being twisted from the lamp unit 2 in a planar view.

In a case where the moving block 46 does not move in the east-west direction, the solar cell panel 51 cannot rotate along the sun, so that the electricity productivity is lowered. In addition, in a case where the direction of the solar cell panel 51 is not changed by the angle changer 4, the solar cell panel 51 deviates from the lamp unit 2, which may spoil the appearance.

However, in the present embodiment, the solar cell panel 51 can rotate the sun, thereby maximizing electricity productivity. Further, it is possible to match the solar cell panel 51 and the lamp unit 2, thereby providing a neat appearance.

The smart solar cell streetlight 1 according to the embodiment of the present invention may further include an illuminance sensor 9 and a motion detection sensor 10.

The illuminance sensor 9 is disposed at a front end part of the housing 21, is operated by power supplied from at least one of the solar cell panel 51 or the battery unit 3, and is controlled by the controller 7. Accordingly, in a case where the illuminance sensor 9 detects the surrounding brightness of the smart solar cell streetlight 1 and generates a sensor signal, the controller 7 adjusts the intensity of light emitted from the LEDs 221 on the basis of the sensor signal, thereby maintaining the surrounding area of the smart solar cell streetlight 1 at a uniform brightness.

The motion detection sensor 10 is also disposed at the front end part of the housing 21, is operated by power supplied from at least one of the solar cell panel 51 or the battery unit 3, and is controlled by the controller 7. Accordingly, in a case where no movement is detected around the smart solar cell streetlight 1 through the motion detection sensor 10, the controller 7 lowers the intensity of light emitted from the LEDs 221 or turns it off to save energy.

Hereinafter, an installation process of the smart solar cell streetlight 1 according to an embodiment of the present invention will be described with reference to the accompanying drawings.

First, an installation direction of the smart solar cell streetlight 1 is determined at an installation location of the smart solar cell streetlight 1.

After the installation direction of the smart solar cell streetlight 1 is determined, the fixing part 64 is separated from the fixing base 61, the stopper 632a is pulled and rotated, and then, the rotation base 62 is separated from the fixing base 61.

After separation, the panel fixing part 52 is separated from the upper coupling part 41.

Then, the direction of the angle changer 4 is determined through the direction detector, and the upper coupling part 41 and the panel fixing part 52 are coupled to each other. The coupling is performed in a state where the solar cell panel 51 and the lamp unit 2 match each other.

After the coupling is completed, the rotation base 62 is inserted into the fixing base 61, the fixing pin 632 is inserted into the guide groove 621 of the rotation base 62 by rotating the stopper 632a, and then, the fixing part 64 is coupled to the fixing base 61 so that the rotation base 62 is firmly fixed to the fixing base 61.

Then, the worker installs the set smart solar cell streetlight 1 at the installation location to complete the installation work.

Accordingly, it is possible to recognize the installation direction of the smart solar cell streetlight at the installation location and easily set the direction of the angle changer 4 before installation, thereby improving the electricity productivity of the solar cell panel. In addition, since all the components are provided in a single set, it is possible to easily perform the installation, and to decrease the overall weight, thereby enhancing movement convenience. Further, since the solar cell unit and the lamp unit are easily separated, it is possible to easily replace the units in a case where parts thereof break.

In the above description of the present invention, even in a case where the embodiments are different, the same reference numerals were given to the same components, and description thereof was omitted as necessary.

In the above description, the specific embodiments of the present invention have been made with reference to the accompanying drawings, but since the above-described embodiments are only preferred examples of the present invention, the scope of the invention is not limited to the above-described embodiments. In addition, it will be understood by those skilled in the art that changes may be made in these embodiments without departing from the principles and sprit of the invention, the scope of which is defined in the appended claims and their equivalents.

### Reference Signs List

1: Smart solar cell streetlight
2: Lamp unit
21: Housing
22: Light part
221: LED
23: Protection panel
24: Streetlight fixing part
3: Battery unit
4: Angle changer
41: Upper coupling part
42: Rotation bracket
421: First bracket
422: Second bracket
43: Link part
44: Motor
45: Screw
46: Moving block
47: Bracket coupling part
5: Solar cell unit
51: Solar cell panel
52: Panel fixing part
6: Direction setting unit
61: Fixing base
611: First hole
612: Second hole
62: Rotation base
621: Guide groove
63: Direction fixing part
631: Pin support
631a: First through hole
631b: Second through hole
632: Fixing pin
632a: Stopper
632b: Support piece
633: Elastic body
64: Fixing part
7: Controller
8: Direction detector
9: Illuminance sensor
10: Motion detection sensor

1. A smart solar cell streetlight comprising:
a solar cell unit that absorbs light and generates electricity;
a battery unit that stores the electricity generated by the solar cell unit;
an angle changer that is operated by the electricity supplied from at least one of the solar cell unit or the battery unit and changes an angle of the solar cell unit; and
a lamp unit that is operated by the electricity supplied from at least one of the solar cell unit or the battery unit and includes a plurality of LEDs.

2. The smart solar cell streetlight according to claim 1, further comprising: a direction setting unit that sets a direction of the angle changer between the angle changer and the lamp unit.

3. The smart solar cell streetlight according to claim 1, further comprising: a controller that controls at least one of the battery unit, the angle changer, or the lamp unit.

4. The smart solar cell streetlight according to claim 3, further comprising: a direction detector that detects a direction of at least one of the direction setting unit or the lamp unit,
wherein the angle changer is set toward the east or the west on the basis of the direction detected by the direction detector.

5. The smart solar cell streetlight according to claim 3, wherein the lamp unit comprises a light part provided with the plurality of LEDs and a housing that protects the light part, and
wherein the direction setting unit comprises a fixing base provided on an upper surface of the housing, a rotation base having at least six guide grooves arranged at equal intervals around the circumference thereof and fitted into the fixing base, and a direction fixing part that fixes a direction of the rotation base around the fixing base.

6. The smart solar cell streetlight according to claim 5, wherein the direction fixing part comprises:
a fixing pin that penetrates a peripheral part of the fixing base and is inserted into or detached from the guide groove at one end thereof;
a pin support part that is spaced apart from the fixing base, is provided on the upper surface of the housing, and supports the fixing pin; and
an elastic member that maintains the fixing pin inserted into the groove.

7. The smart solar cell streetlight according to claim 1, wherein the direction setting unit further comprises: a fixing part that prevents the rotation base from being separated from the fixing base.
